(19) United States
(12) Patent Application Publication
(10) Pub. No.: US 2007/0220696 A1
(43) Pub. Date: Sep. 27, 2007

(54) Wiper for an automobile rear-view mirror

(76) Inventor: Chiang-Fen Lin, Yongkang City (TW)

Correspondence Address: CHIANG-FEN LIN, P.O. BOX 90, Tainan City, 70499, TW

(21) Appl. No.: 11/389,219

(22) Filed: Mar. 27, 2006

(51) Int. Cl. B60S 1/56; B60S 1/60; B60S 1/24; B60S 1/26

(52) U.S. Cl. 15/250.003; 15/250.3

(57) ABSTRACT

A wiper for an automobile rear-view mirror includes a transmission motor installed at the rear side of a rear-view mirror. The transmission motor is provided with a worm engaged with a transmission gear, which is eccentrically provided with a pivot connected with a connecting rod having the other end pivotally connected with a driving rod. The driving rod is disposed with a fixing shaft inserted through the surface of the rear-view mirror and secured with a fixing base having a wiping bar fitted thereon. The wiping bar can be actuated to swing back and forth for wiping out water drops on the surface of the rear-view mirrors to enable a driver to clearly watch the image reflected in the rear-view mirrors and to drive with safety.

### BACKGROUND OF THE INVENTION

1. Field of the Invention

This invention relates to a wiper for an automobile rear-view mirror, particularly to one able to surely wipe out water drops on the surface of the rear-view mirror of an automobile to enable a driver to clearly watch the moving conditions of vehicles coming from behind.

2. Description of the Prior Art

As a matter of fact, it is absolutely important for a driver to watch the moving condition of vehicles coming from behind before making a turn, overtaking a car, changing lanes or parking. However, during raining, the rear-view mirrors of an automobile will be covered with rain water and unable to reflect images clearly, and as a result, the driver cannot clearly watch the traffic conditions of vehicles coming from behind on the rear-view mirrors, thus affecting safety of driving and likely to cause an accident.

### SUMMARY OF THE INVENTION

The objective of the invention is to offer a wiper for an automobile rear-view mirror, able to surely wipe out water drops on the surface of the rear-view mirror to enable the driver to clearly watch the images reflected in the rear-view mirror.

The wiper for an automobile rear-view mirror in the present invention includes a transmission motor installed at the rear side of a rear-view mirror, and a worm engaged with a transmission gear, which is eccentrically provided with a pivot connected with a connecting rod that has the other end pivotally connected with a driving rod. The driving rod is disposed with a fixing shaft inserted through the surface of the rear-view mirror. The fixing shaft is secured with a fixing base having a wiping bar fitted thereon.

### BRIEF DESCRIPTION OF DRAWINGS

This invention will be better understood by referring to the accompanying drawings, wherein:

FIG. 1 is a perspective view of a wiper for an automobile rear-view mirror in the present invention;

FIG. 2 is a front view of the wiper for an automobile rear-view mirror in the present invention;

FIG. 3 is a cross-sectional view of a wiping bar in the present invention;

FIG. 4 is side cross-sectional view of the wiper for an automobile rear-view mirror in the present invention;

FIG. 5 is a front view of the wiping bar in a reciprocating wiping condition in the present invention; and

FIG. 6 is a front view of the wiping bar in a lowest wiping condition in the present invention.

### DETAILED DESCRIPTION OF THE PREFERRED EMBODIMENT

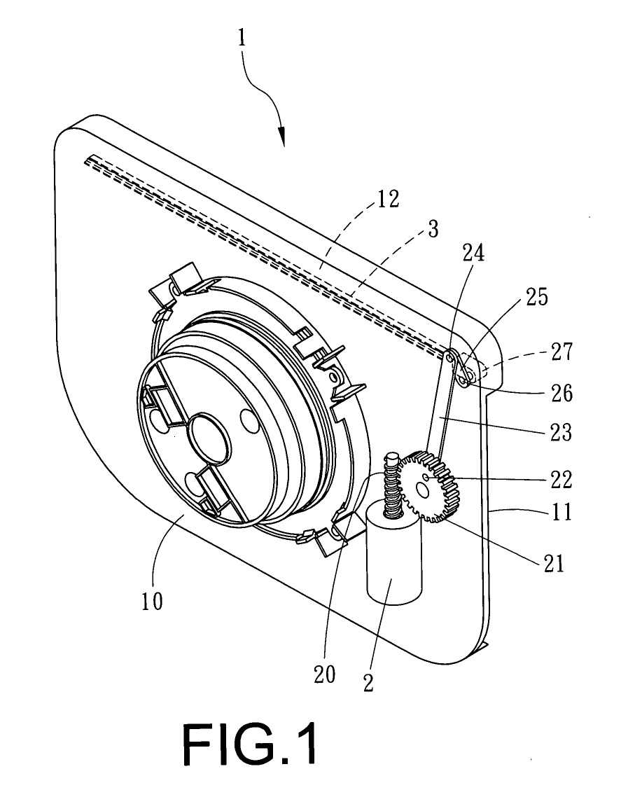

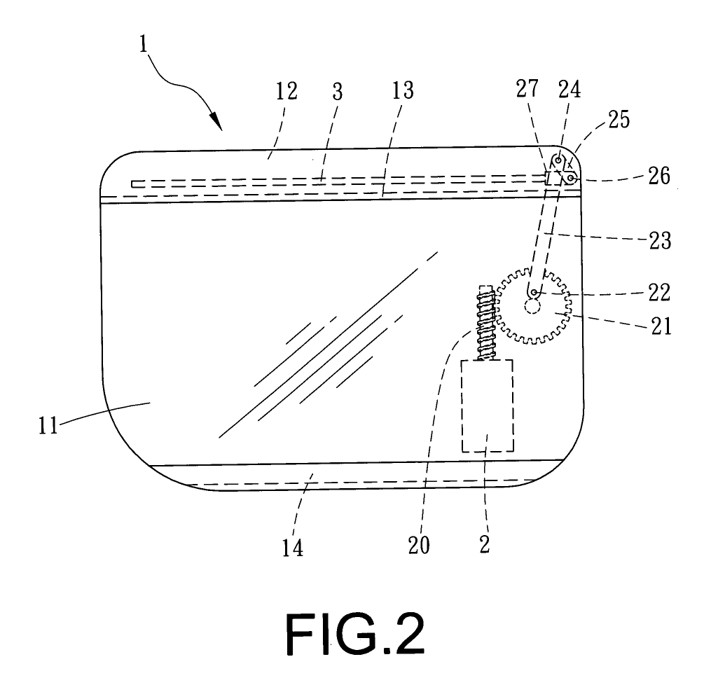

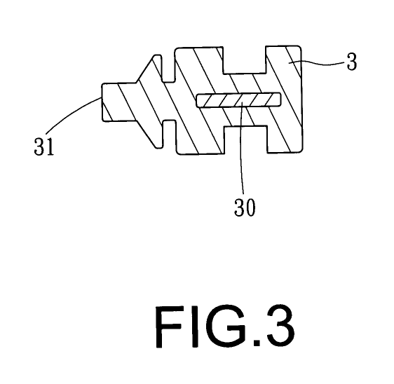

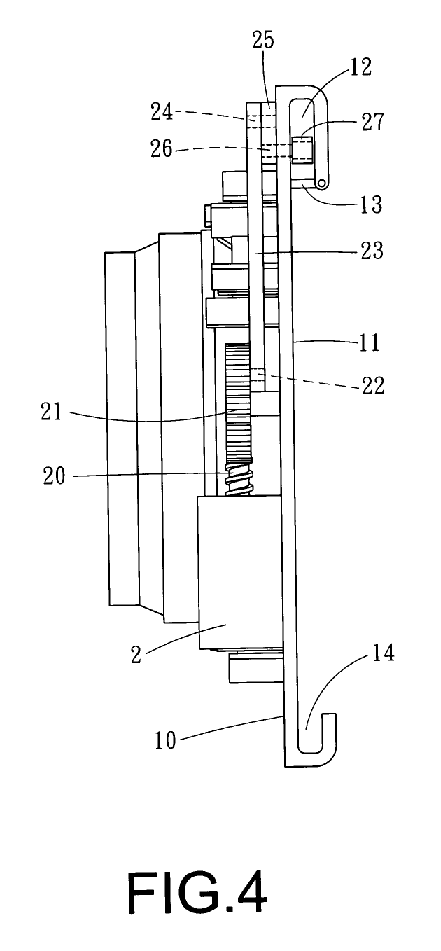

A preferred embodiment of a wiper 1 for an automobile rear-view mirror in the present invention, as shown in FIGS. 1-4, includes a base 10, and a transmission motor 2 installed at the rear side of the base 10. The transmission motor 2 is provided with a worm 20 engaged with a transmission gear 21 eccentrically provided with a pivot 22 connected with a connecting rod 23, which has the other end pivotally connected with a driving rod 25 by a pivot 24. The driving rod 25 has the other end provided with a fixing shaft 26 inserted through the surface 11 of the rear-view mirror 1 and mounted with a fixing base 27 having a wiping bar 3 fitted thereon. The wiping bar 3 is made of a soft material, having an elastic member 30 installed lengthwise in the interior for elastically support the wiping bar 3, as shown in FIG. 3. The rear-view mirror 1 has its upper edge formed with an accommodating chamber 12, as shown in FIG. 2, for receiving the wiping bar 3 therein, with the wiping surface 31 of the wiping bar 3 closely contacting the surface 11 of the rear-view mirror 1. The accommodating chamber 12 has its lower edge provided with a cover plate 13 for closing the accommodating chamber 12. Further, the surface 11 of the rear-view mirror 1 has its lower edge formed with a recessed groove 14, as shown in FIG. 4.

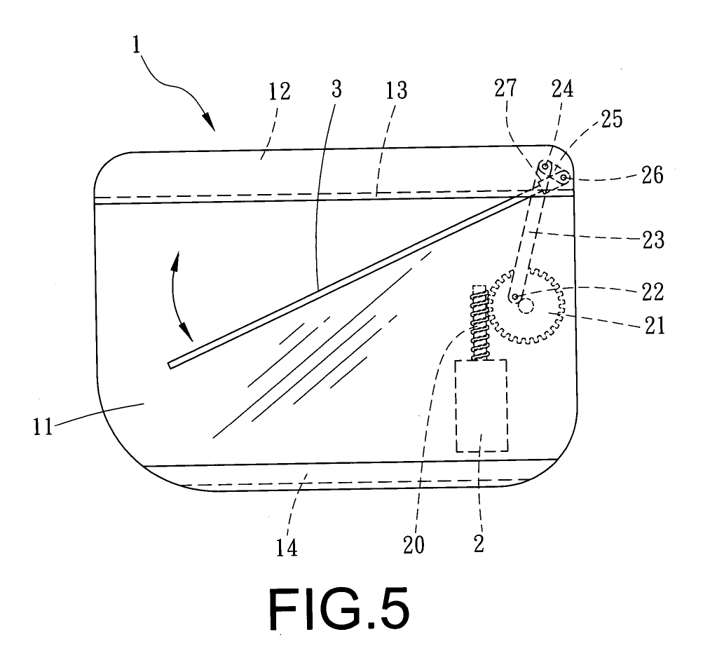

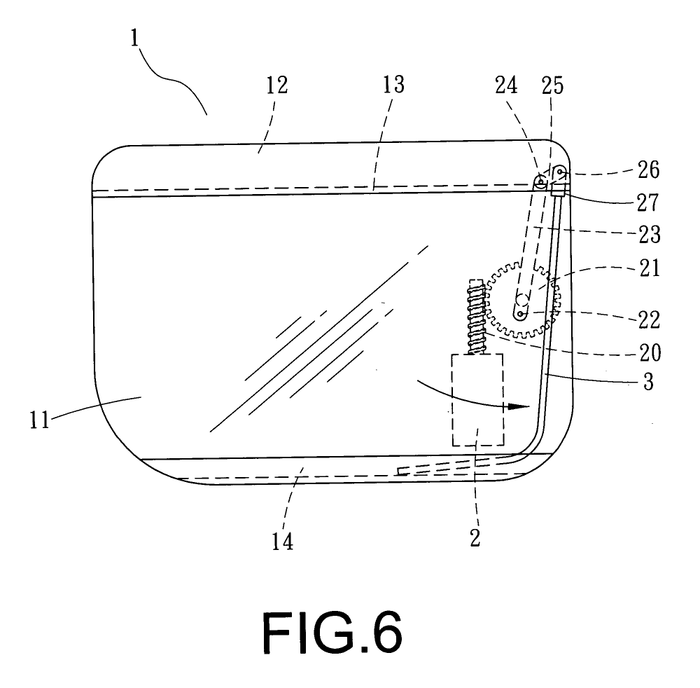

In using, referring to FIGS. 2, 5 and 6, when it is raining and water drops remain on the surface 11 of the rear-view mirror 1, simply start the transmission motor 2 on the base 10 to drive the worm 20 to rotate and actuate the transmission gear 21 to rotate. Synchronously, the lower end of the connecting rod 23, which is pivotally combined with the transmission gear 21 and has the rotating shaft of the transmission gear 21 acting as a pivot, is rotated, and the driving rod 25, which is pivotally connected with the upper end of the connecting rod 23 and has the fixing shaft 26 serving as a pivot, is rotated together with the fixing shaft 26. In the meantime, the fixing base 27 at the other end of the fixing shaft 26 will be rotated and the wiping bar 3, with the fixing shaft 26 acting as a pivot, will be actuated to swing back and forth in a certain angle. As mentioned above, the wiping bar 3 is made of a soft material, with the elastic member 30 lengthwise in the interior; therefore, when the wiping bar 3 performs wiping and pushes against the lower edge of the surface 11 of the rear-view mirror 1, the outer end of the wiping bar 3 will be elastically bent along the inner edge of the recessed groove 14 of the surface 11, and the elastic member 30 inside the wiping bar 3 will become elastically curved, as shown in FIG. 6. Thus, the wiping bar 3 is able to completely wipe out water drops on the surface 11. When the wiping bar 3 is swung upward and separated from the recessed groove 14, the elastic member 30 inside will be released from compression and recover its elastic force to make the wiping bar 3 recover its straight shape to continue wiping work, as shown in FIG. 5. By so designing, the wiping bar 3 can be actuated to swing back and forth for wiping out water drops on the surface 11 to enable a driver to clearly watch the image reflected in the rear-view mirror 1 and to drive with safety.

While the preferred embodiment of the invention has been described above, it will be recognized and understood that various modifications may be made therein and the appended claims are intended to cover all such modifications that may fall within the spirit and scope of the invention.

What is claimed is:

1. A wiper for an automobile rear-view mirror, said wiper comprising a transmission motor installed at the rear side of a rear-view mirror, said transmission motor provided with a worm engaged with a transmission gear, said transmission gear eccentrically disposed with a pivot connected with a connecting rod, said connecting rod having the other end pivotally connected with a driving rod, said driving rod provided with a fixing shaft inserted through the surface of said rear-view mirror and secured with a fixing base, said fixing base fitted thereon with a wiping bar.

2. The wiper for an automobile rear-view mirror as claimed in claim 1, wherein said wiping bar is made of a soft material, having an elastic member fixed lengthwise in the interior.

3. The wiper for an automobile rear-view mirror as claimed in claim 1, wherein said rear-view mirror is formed with an accommodating chamber at the upper edge for receiving said wiping bar therein, said accommodating chamber having its lower edge provided with a cover plate.

4. The wiper for an automobile rear-view mirror as claimed in claim 1, wherein said rear-view mirror has its lower edge formed with a recessed groove.
